(19) United States
(12) Patent Application Publication
(10) Pub. No.: US 2015/0262204 A1
(43) Pub. Date: Sep. 17, 2015

(54) Sales and fundraising computer management system with staged display.

(71) Applicants: Ross T Helfer, Cornelius, NC (US); Andrew B. Whitaker, Cornelius, NC (US)

(72) Inventors: Ross T Helfer, Cornelius, NC (US); Andrew B. Whitaker, Cornelius, NC (US)

(21) Appl. No.: 14/204,085

(22) Filed: Mar. 11, 2014

(51) Int. Cl. G06Q 30/02

(52) U.S. Cl. CPC G06Q 30/0202

(57) ABSTRACT

The present invention provides a computer implemented method for processing and analyzing marketing, sales and fund raising prospect data comprising the steps of: enabling a user of a computer or mobile computing device to input sales activity and prospect information resulting in a display of an analytical representation on a computer or mobile device of the user's campaign status as demonstrated through defined stages of the campaign phases across the plurality of prospects as relating to campaign objectives and further quantifying the campaigns probable outcomes through predictive analysis that embodies campaign pulse analytical measurements that quantifies unrelated data and events of the campaign to better determine probability of actual campaign outcomes.

### TECHNICAL FIELD

The invention relates to computer-implemented techniques for managing sales and marketing activity and managing fundraising activity forecasting models through a staged data environment that may use campaign pulse metrics.

### BACKGROUND

Businesses arid Non-Profits perform sales forecasting and activity monitoring in order to measure sales and fund-raising progress to assist managers and executives in managing resources to achieve targeted results. Sales forecasting and activity monitoring is a difficult and expensive operation that often produces inaccurate results leading to mismanaged prospects and missed targets. Computerized sales and marketing systems lack the ability to relate real-time data to relevant processes of the sales or fund raising campaign's critical stages showing the value proposition of each phase of a campaign in relation to one another in an easy to identify format across varying types of computing devices. Resources and efforts are often wrongly utilized when the entirety of a campaign's critical stage's prospect valuations are not able to be seen as they relate to outcome probabilities. This lack of a campaign wide view of prospect valuations by stage leaves critically needed areas to often go unnoticed at times they require immediate action. In addition, current sales and marketing systems lack the ability to collect arid employ pulse analytics across all campaign data, related arid nonrelated, and factor it into analytical outcomes causing current analysis from these systems to not reflect the subjective pulse of a campaign.

### SUMMARY

The invention is directed to the problem of directing resources and actions at the critical targeted stages of a sales campaign or fundraising campaign. Management of these activities requires real-time prospect analysis at these critical stages so that resources are not underutilized and yield their highest efficiencies.

In general, the invention is directed to a distributed computer application for presenting real-time sales or fund raising campaign information and analytics, from actual campaign events, against which user interface objects enable campaign objectives and prospects data, regardless of time of origination in the system, to be analyzed and displayed through predefined campaign stages represented through graphical interface embodiments resulting in more accurately focused sales actions toward a prospect and a plurality of prospects in a sales or fund raising campaign.

According to one aspect, the invention is directed to a system including a database of prospect's data reflecting demographics, facts and conditions that may be evaluated as a measurement of probabilities of outcome against which actual campaign activities may be adjusted accordingly.

In one embodiment, the system displays system analysis of a plurality of prospects across defined campaign stages identifying the highest actionable items and individual campaign stage trends so that efforts and resources are best targeted toward key prospects and those actions critical for producing the greatest potential yields.

The system may through another embodiment enable users to enter subjective evaluations using a uniform scale to evaluate various sales or fund raising processes, events and data through a campaign metric that enables these unrelated data and events across the entire campaign to be analyzed in conjunction with one another producing a unique data point that reflects the pulse of the campaign.

The system may through another embodiment, enable users to evaluate campaign outcomes by interacting with the system through adjustable graphical user interface controls that provide real-time prospect and campaign outcomes as implemented. Outcome probabilities are then recalculated and displayed in real-time through the graphical user interface so that the user can reallocate efforts and resources from the plurality of prospects to the targeted prospect with a campaign wide understanding of the decision.

### DESCRIPTION OF DRAWINGS

FIG. 1 is a functional scheme of the application of user input and external data input and the effect progression analysis has on the graphical user interface embodiments as a result of such input according to the present invention.

FIG. 2 shows the graphical user interface embodiments displaying an end user's campaign progression as it relates to overall campaign objectives.

FIG. 3 shows a graphical user interface embodiment used for inputting a prospect's targeted sales or funding objective as it compares to a system calculated projected outcome and the effects such an outcome may result on the entire campaign demonstrated in real time.

FIG. 4 shows graphical user embodiments used to demonstrate a prospect's progression status and system score as compared to a campaign of prospects and the ability to sort the prospects according to these evaluations.

FIG. 5 shows graphical user interface embodiments used for entering a prospect's affinity factors and the resulting system analysis displayed to the user.

FIG. 6 shows a function scheme of the application running as a standalone application on computers and mobile devices and a function scheme of the application running in an enterprise solution where user computers and mobile devices exchange data and communications with cloud based server systems and remote computers and or servers.

FIG. 7 shows a functional scheme of user applications receiving data to their devices from an enterprise system, communicating campaign results back to the enterprise system and then receiving back predictive analysis to be applied to system prospects, bettering campaign future outcomes.

FIG. 8 shows graphical user interface embodiments representing the campaign stage with prospect quantities as relating to their position in the campaign with prospect aging and prospect outcome valuation projections.

FIG. 9 shows graphical user interface embodiments representing the entire campaign queried by representative displaying each representative's prospects status and campaign activity.

FIG. 10 shows a functional scheme of the system data flow and analytical output through the campaign stages as defined by the user from initial prospect input until completed through the final stage.

### DETAILED DESCRIPTION

The various embodiments of the invention stem from the realization that sales campaign management and fund raising campaign management computer software applications suffer from a lack of applied progression analysis demonstrated across key campaign stages with trend direction indicated through graphical user embodiments that provide real time campaign assessments across the critical campaign stages while demonstrating the stage value proposition as the users interact with the system. This invention addresses a fundamental issue lacking in other systems by delivering a unique perspective of the campaign through the graphical user interface demonstrating the status of a campaigns phases and prospect's value propositions across the relevant stages of the campaign with trend analysis as relating to probable outcomes indicated by user's the systems analytics of the inputted data. The invention includes a pulse analysis mechanism whereby the system enables system input of a universal scale to be applied across non-related data types producing a campaign wide measurement yielding the pulse of the campaign. The invention then completes the analytical model by focusing outcome analysis against future prospects by utilizing a predictive modeling calculus, derived by analyzing key campaign stage data points in conjunction with the pulse calculus, from which more efficient management decisions can be then be applied to the balance of the campaign. Trend indicators on key data points are demonstrated through the graphical user interface showing directional trends in real time. The invention is unique in that it enables a user to maintain focus on immediate actions necessary to maximize an individual prospect's potential from stage to stage while simultaneously realizing the effects of events and decisions at the prospect level have on the entirety of the campaign.

Thus, the various embodiments of the invention herein uniquely combine data that is contained in one area, for example the initial prospect contact stage, and combine that with other data points such as those from outcome probability analysis, through a graphical user interface, to direct actions where a user's time can best be appropriated to yield the highest outcome. Based on the easy to visualize graphical embodiments that demonstrate the progression of prospects and the value proposition of those prospects, the user is relieved from time spent analyzing their prospect leads, active prospects and past activities and instead can more efficiently maintain their current activities on the highest valued tasks as related to probable outcomes. The application utilizes key visual elements that are easily recognized directing the user to relevant tasks across each stage maximizing productivity through higher value actions. These values are derived by analyzing the prospect against the entirety of the campaign across several key data points. The selected data points can be specific to the nature of the sales or fund raising campaign and can be continually analyzed against completed prospects data points, thus more closely aligning future targeted events toward higher probable outcomes. This forward looking analysis is tightly integrated throughout the user interface providing real-time outcome probabilities across the application. The system can quickly separate at risk prospects from high valued prospects and apply outcome analysis against future prospects enabling a higher level of screening before entering them into the active prospects stage. This forward looking analysis continually improves the user's efficiencies for work processes as a campaign progresses throughout the year and more closed prospect outcome data is available to focus against future prospect data.

Further embodiments of the invention can also be used to provide an “early warning” to a probable failure of future prospects through identifying current prospect data and patterns in a problem reporting system and matching such patterns to future prospects identifying risk. Some of these various embodiments will be described below by way of example and with reference to the drawings.

The system can contain document templates to further expedite a user's workload. These templates can be accessed directly in the system so that a user may quickly send a thank you notice or other communication with just a few keystrokes or touch events on a screen.

The system can improve on its analysis of probable outcomes by enabling additional third party data sources to be requested and received by the system as relating to a prospects applied demographics. These data points can be assessed individually or quantitatively against previous outcomes of the campaign, further refining the predictive outcome of a prospect.

The system may also provide a means of color coding its interface embodiments thus producing an additional means of indication as to the state of a campaign item data point or stage as it relates to the pre-established criteria for that data point or stage. The color of an interface embodiment may also be a representation of that data point or stage as it compares to similar data or stages within the campaign as a whole. An example of an interface embodiment utilizing such color coding is the number representing the prospects currently residing in stage one could be colored green. This would show not just the number of prospects in stage one but would further demonstrate to the user that the color is indicative of the quantity being above normal for the campaign at large thus signaling to the user that no additional prospects are suggested at this time. Likewise if the same stage one prospect number were colored red, this could be representative of a substantive deficiency for prospects at that stage and immediate action is suggested to the user to improve the quantity. There may be multiple colors employed for indicating through an interface embodiment.

Another application of color a coded interface embodiment in the system is to demonstrate trend analysis as it applies to a stage. The stage bar identified in the technical drawings may be used to represent not just a stage of the campaigned and that stages associated data, but can indicate stage's trend by color of the stage line. A green stage line could be representative of a stage trending in a more positive direction while a red stage line might indicate a stage trending in a poorer direction suggesting immediate action to the user to improve that stage's condition. A stage that is within neutral or acceptable guidelines may be indicated by a color such as gray. The system could allow administrator level permissions to set interface embodiment colors by a campaign manager to best identify subject trends at his discretion.

The invention may also be used to quantify data regarding event processes, sales or fund raising functions, campaign information and other subjective campaign properties through a data gathering methodology called pulse that can extend across unrelated campaign data points, functions, and events to determine the overall pulse or health of the entire campaign. The pulse measurement methodology is uniform in scale across all areas where gathered utilizing a measurement protocol such as, high, medium, low or good, fair, poor, regardless of the subject type evaluated. The uniformity of the measurement scale is the critical criteria for a system pulse measurement. It is the uniformity of measurement criteria across nonrelated data, events and information that yields a universal pulse data point. The totality of this input may be analyzed through weighted considerations giving a higher consideration to campaign process, events or informational contexts that may greater effect campaign outcomes than others. The system's pulse analysis is unique in its assessment type because it facilitates unrelated campaign processes and events to be assessed comparatively and thus derive a campaign evaluation unique to other data points or characteristics in the system that may be applied to other analysis including predictive analysis models as a means of better quantifying data points and forecasting probabilities of outcomes.

The invention can be applied as a software application on a standalone computer, tablet, mobile phone or any device capable of running a software application either hosted on the actual device or remotely through a server based application thus accessing this application across a network or the internet.

The invention also can be applied in an enterprise model with a primary application hosted on a remote computer or server and end users' node applications can be hosted on individual computers, tablets, or mobile devices capable of running a software application. In this applied model the system may be connect across a wired network or connected wirelessly such as across the internet. This application is further described in the drawings.

Accordingly, the invention may take the form of software embodiment (including firmware, resident software, micro-code, etc.) or any embodiment that may be used in a computer based device. Computer program code for carrying out operations for aspects of the present invention may be written in any combination of one or more programming languages, including an object oriented programming language such as Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer. or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, the present invention is explained in more detail in relation to the enclosed drawings, in which the systems functions and embodiments are detailed.

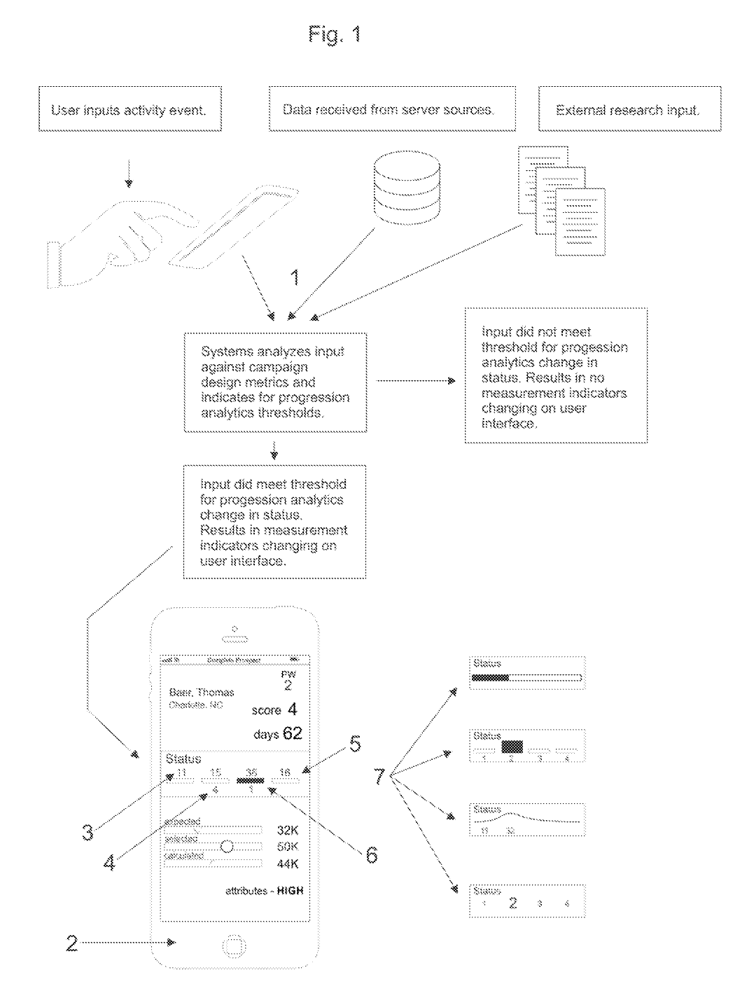

FIG. 1 is block diagram with functional illustrations showing system input sources 1 and the resulting system analytics generated and displayed through user interface embodiments. As various forms of input 1 are received by the system, system analytics compare the input against user-defined progression thresholds of campaign events, determining if the prospect's status in the system is to be modified accordingly resulting in modification to the graphical user interface embodiments on their device 2. The graphical progression status embodiment 5 represents the stages of a campaign through graphical interface embodiments. A unique indicator 6, of the graphical progression embodiment 5 displays the stage of progression the prospect is currently in as it relates to a campaign. The graphical progression embodiment 5 represents the stages of a campaign a prospect progresses through and can be identified through system analytics as located at a given stage. The number of days a prospect's status remains at a given stage is exhibited by a numerical value embodiment 3 displaying in close proximity to each stage. When a prospect lasts longer than the predetermined target for the term of a stage, a numerical value 4 is displayed in close proximity to the graphical stage indicator embodiment for that stage, showing the user the aging in days over that stage's term target. The graphical progression status embodiment 5 may take several forms 7 which demonstrate a progression of stages indicating a prospect's status as it relates to the stages of a campaign.

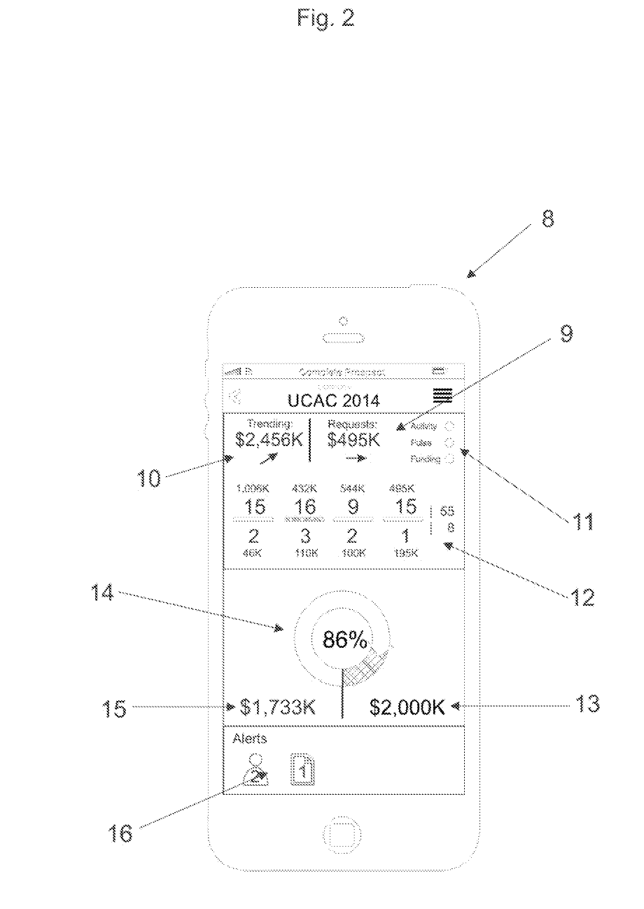

FIG. 2 is a diagram of system graphical embodiments displaying a user's campaign status across a plurality of prospects on a mobile device 8. The plurality of prospects is exhibited across the stages of a campaign through the graphical progression interface embodiment 12. Projected campaign outcome is analyzed in real-time by the system and displayed by a numerical embodiment with a trend indication displayed by a graphical embodiment in close proximity to one another 10. Pending requests are displayed by a numerical embodiment with a trend indication displayed by a graphical embodiment in close proximity to one another 9. System analysis of activity levels, pulse calculus, and funding calculus is demonstrated through a state of each versus their prior state using a measurement such as advancing, declining or neutral and displayed through graphical interface embodiments 11 using user defined color indications as to their status at a given point in time. The campaign's total sales or total fundraising goal, as defined by the user, is quantified as processes take place in the system and is displayed as a graphical user interface embodiment 14 demonstrating the campaign's progression as it relates to a beginning and successful completion. The campaigns completed sales or funds raised for the plurality of prospects managed by the user's system are displayed as a numerical value embodiment 15. The campaign's total sales goal or total fund raising goal for the plurality of prospects managed by the user's system is displayed as a numerical embodiment 13. System alerts and user notifications are exhibited to the user by graphical interface embodiments 16.

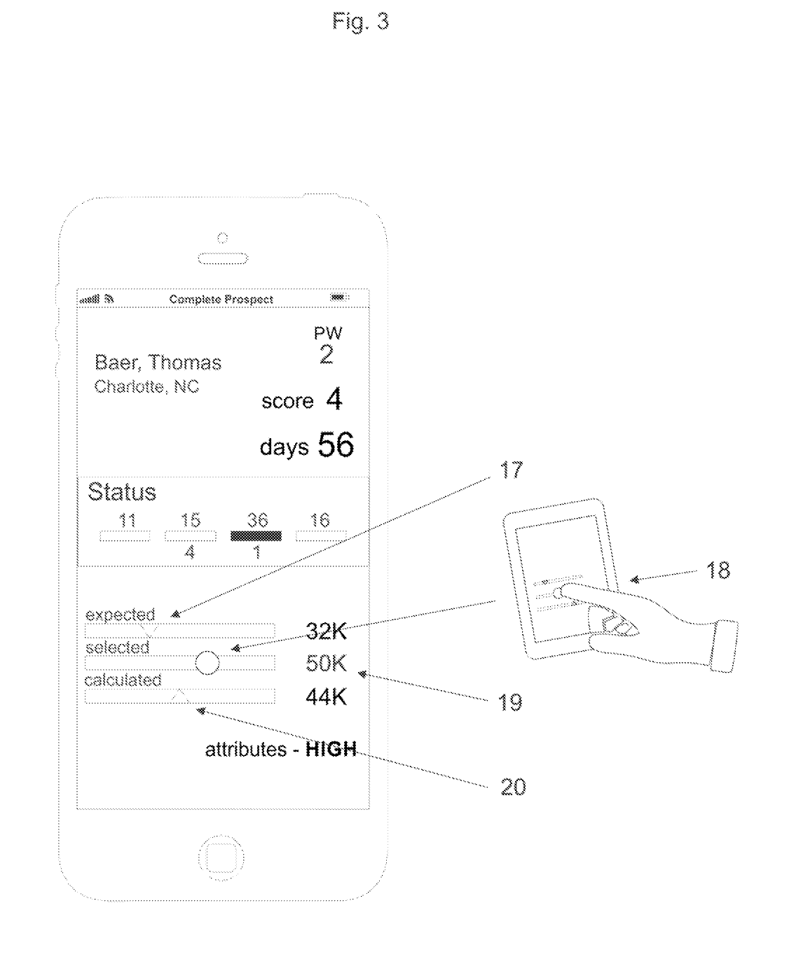

FIG. 3 is a diagram of system graphical embodiments 17 19 20 and user interface control 18 used to evaluate and adjust a prospects targeted sales goal or targeted fund raising goal. The expected sales goal 17 or fund raising goal embodiment 17 is quantified by the system based upon historical prospect data entered in the system and processed by the systems analytics resulting in the numerical value embodiment 19 and the position of the graphical embodiment 17 displayed on the user's device. The calculated sales goal embodiment 20 or fund raising goal 20 is quantified by the system by quantifying the current prospects selected goal 18 with the plurality of prospects in the system that are pending an outcome against the plurality of prospects in the system that have achieved an outcome as relative to the campaigns gross objective by the system's analytics resulting in the numerical value 19 and the position of the graphical embodiment 20 displayed on the user's device.

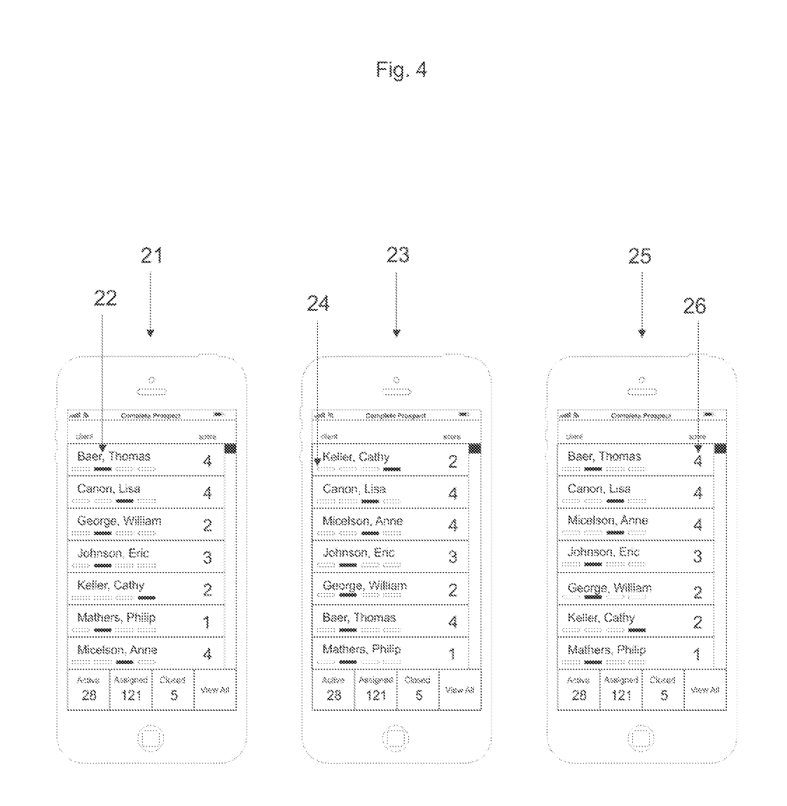

FIG. 4 is a diagram of a system graphical embodiment 24, on a computing device 21, used for identifying the stage a prospect is in when viewing a plurality of prospects. The plurality of prospects may be sorted by the graphical embodiment 24, on a computing device 23, resulting in a scrollable list of a plurality of prospects that may be sorted in an ascending or descending order as relating to the stage of the prospects. Another graphical embodiment 26 displays the system generated score, which represents the propensity of the prospect to the campaign. The plurality of prospects may be sorted by the graphical embodiment 26, on a computing device 25, resulting in a scrollable list of a plurality of prospects that may be sorted in an ascending or descending order as relating to the propensity of the prospects to the campaign.

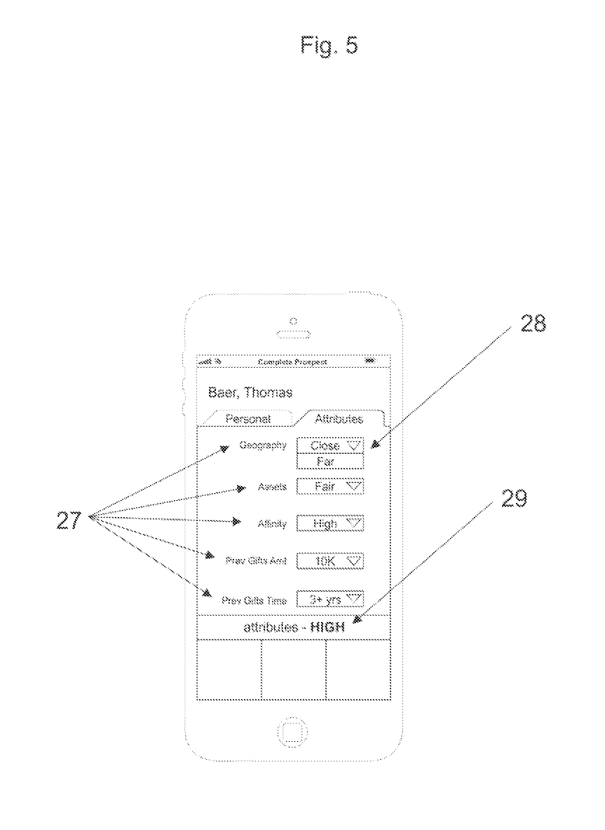

FIG. 5 is a diagram of system embodiments 28 and 29, on a computing device, used for inputting prospect attributes that are used by the system for assessing a prospects affinity for a campaign. Embodiment 27 displays the user defined attributes the user may enter into the system through each attribute's input embodiment 28, by selecting from a list, selecting a toggle input field, typing data into a field or inputting data with a stylus. The inputted data for each attribute is used by the system as a factor in calculating the prospects score for their propensity to the campaign. The attribute types 27 may be defined by the user and the attribute corresponding values 28 may be defined by the user.

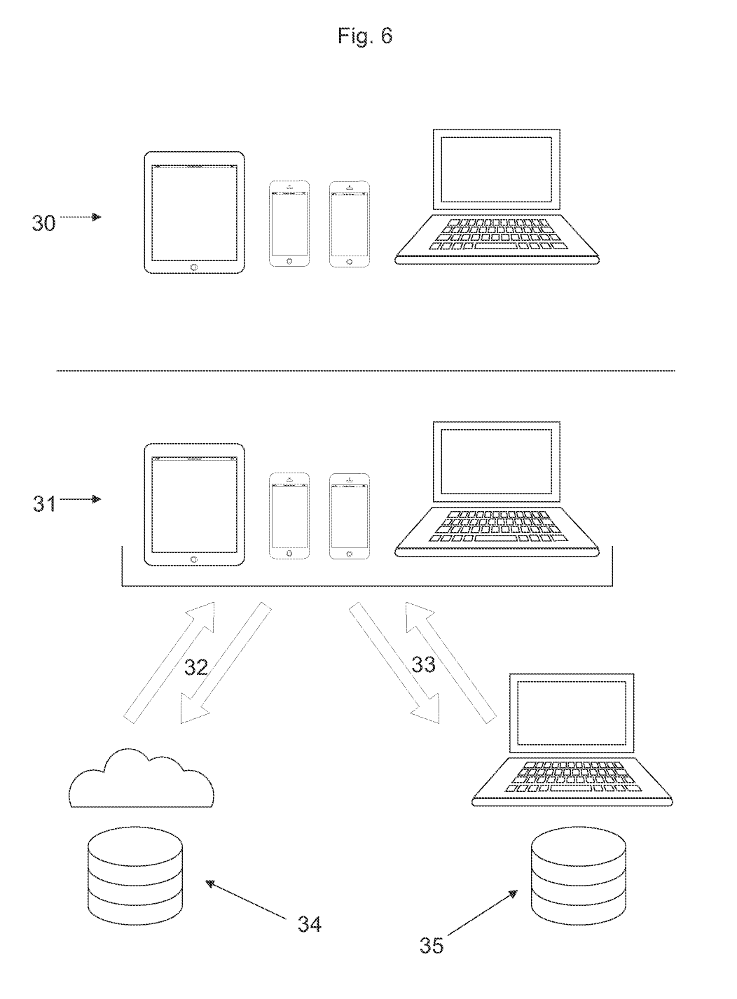

FIG. 6 is a diagram of the system installed on one or more independent computing devices 30 operating independently on those devices and the independent devices 31 connected to an enterprise application running on a computing device 35 through an internet, intranet or network connection 33 and may employ a cloud based data hosting environment 34 connected through an internet connection 32. When employed as a standalone system 30 operating solely on user independent computing devices the system acts independently and can facilitate all operations on the computing device on which it is installed. In this environment the system may receive prospect data from a third party contact manage system, spreadsheet or other computer data management system by importing the data into the system or pasting the data through a copy to clipboard and paste to system methodology. In this environment the user independent computing devices may also export the data in the system for use in a third party application on another computing device. When the system on the user independent computer devices 31 connects to an enterprise module of the system 35 the data is shared between the systems and the enterprise module can perform analytics across data from a plurality of independent user computing devices.

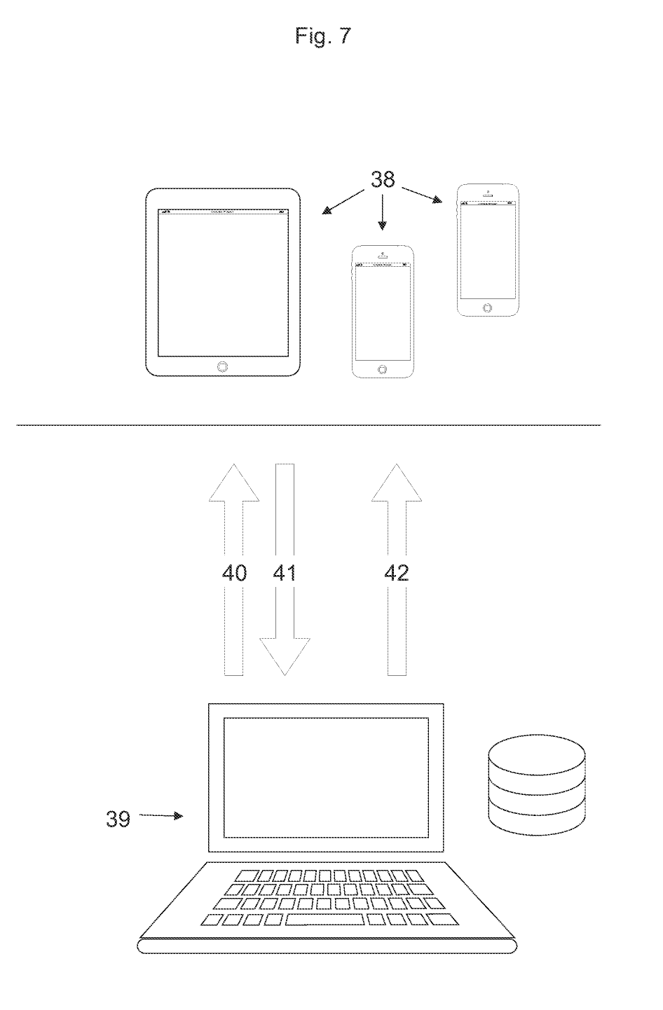

FIG. 7 is a diagram of independent user computing devices systems 38 connecting to an enterprise application 39 that performs predictive analytics. The independent computing devices receive 40 prospect data from the enterprise application. The independent computing devices systems send 41 resulting activity and prospect affected data back that the users entered into their system on these independent computing devices to the enterprise application 39. The enterprise application performs analytics on the data sent 41 from the independent systems of which the outcomes from these analytics can be assessed against addition prospect data resulting in a predictive analysis outcome dataset of prospects of which would have a high propensity for the campaign. The enterprise application utilizes an analysis method which analyzes events that have resulted in positive and negative outcomes for the campaign from received 41 data. The enterprise system then applies learned attributes about favorable outcomes received and then applies analytics to additional prospects against these learned attributes and scores future prospects as a propensity for the campaign as a result of those outcomes. The enterprise application can further apply these predictive analytics directly within the users independent computing devices 38 resulting in a rescoring of the prospects residing on those devices so that they are better scored for a propensity of the campaign. This process of outcome based data being sent 41 to the enterprise application, analyzed for outcome based information in which predictive analysis models can be assembled and applied against future prospects and pending prospects on independent devices is constantly repeated each time data is received 41 and sent 42 by the enterprise system.

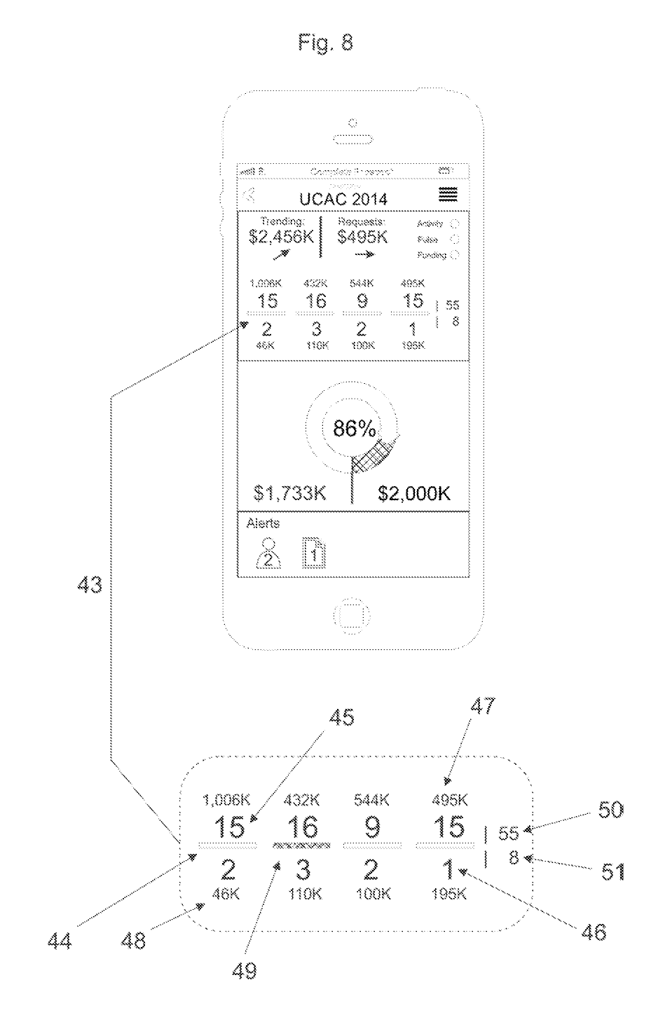

FIG. 8 is a diagram of the campaign stage progression analysis interface embodiments 43. The plurality of prospects is exhibited across the stages of a campaign through the graphical progression interface embodiment 43. The system performs analytics filtered by campaign stage evaluating the prospects in the system for data that meets the user defined criteria for each stage 44 of the campaign and displays a numerical value 45 in close proximity to the stage graphical interface embodiment representing the quantity of prospects that meet the user defined criteria for that stage. Each stage of the campaign, represented by a graphical interface embodiment 44, may also display to the user the number of prospects in the user's system that have exceeded user defined terms for each stage with a numerical display 46 in close proximity to its related stage's graphical interface embodiment. The system can alter the colors of stage interface embodiments 44 and 49 indicating the result of stage trend calculus performed by the system using varying colors with each color indicating a different direction for the state of the trend for the stage. The system can also display a numerical calculus representing a cumulative value of the prospects residing at a given stage and display the result in close proximity to the stage interface embodiment 47 such as the total value the prospects may present to the campaign.

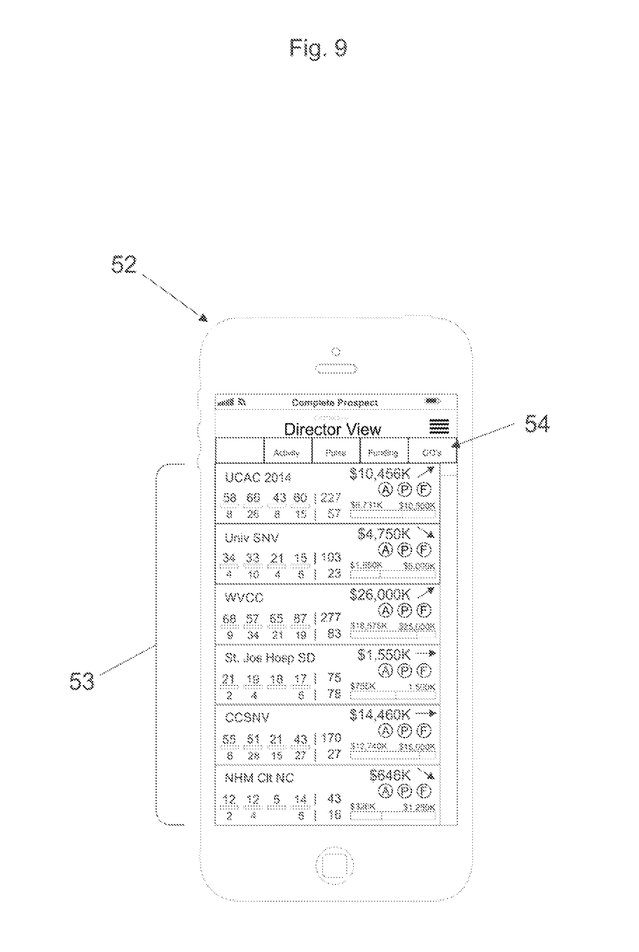

FIG. 9 is a diagram of a system output of a queried set 53 of representative's or organization's prospects summarized by representative or organization and displayed in a linear order utilizing the staged progression analysis as an identifier as to the status of each on a mobile device 52. The query type is selectable by a menu displaying options on interface buttons.

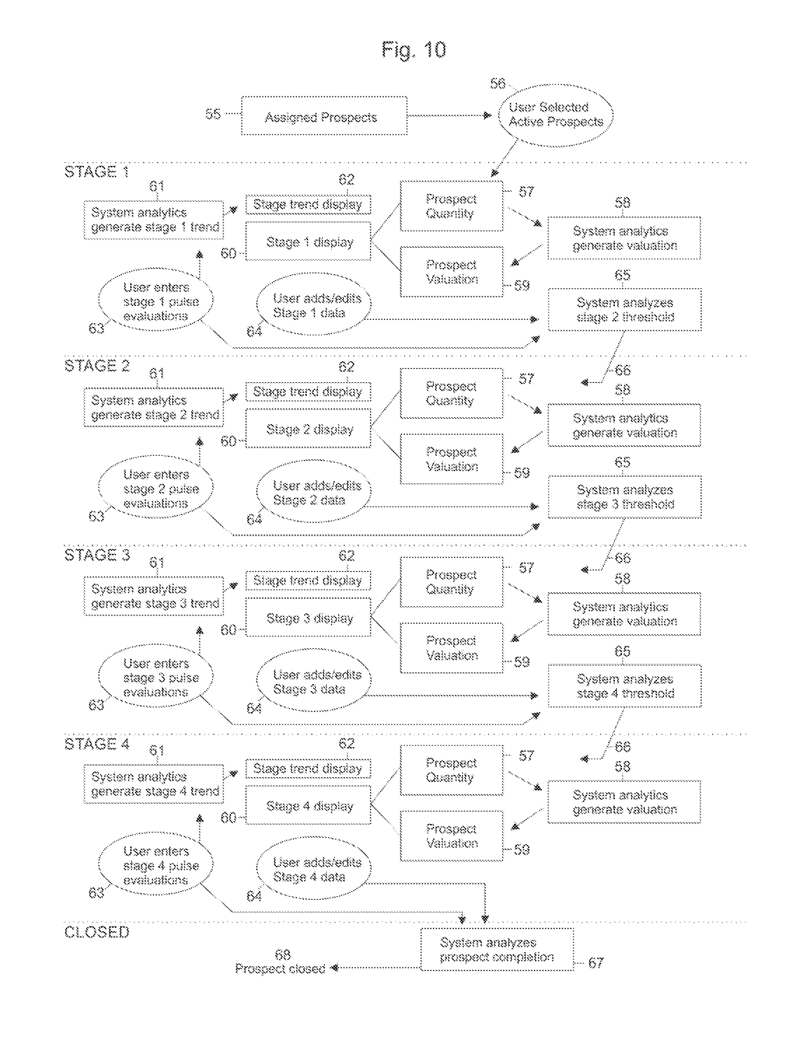

FIG. 10 is block diagram of the user defined system stages which facilitate the campaign management metrics for the system. The user defines the parameters for each stage against which the prospect's data must exceed in order to graduate to the next system stage. Following the administration of setting stage parameters the user begins by adding prospects into the system 55. The user then selects from the total number of assigned prospects and may employ system analytics to assist in the selection of prospects. The selected prospects 56 are then categorized into the initial stage by the system 57. Each system stage displays the stage's information through a series of associated interface embodiments 60 using an interface embodiment to represent the stage and in close proximity displays the quantity of prospects 57 associated to that stage through another interface embodiment and may also display the prospects valuation 59 associated to that stage, generated by the system analytics 58, through another interface embodiment. The system may analyze certain data points against previous data points utilizing analytical methods 61 such as a moving average scale producing a stage's trend that may be represented through an interface embodiment representing direction or by coloring an interface embodiment in which differing colors could represent varying trend directions. As the user interacts with the system by entering new data and editing existing data 64 the system analyzes the stage's associated data 65 to determine if the next stage's user defined threshold has been met. The system may also employ a pulse metric by allowing the user to apply a subjective universal scale across related and unrelated stage data 63 generating a pulse measurement of the stage with which the system may then apply against additional analytics 61 65 generating a higher valued predictive analytic. The system stage analytics are repeated as the user interacts with the system constantly analyzing each prospects data as it is added to or modified to determine if the prospects data satisfies the next stages threshold 65 and if so categorizes the prospect for the next stage 66. Once a prospect has reached the final campaign stage in the system the prospects data is then analyzed against completion criteria 67 to determine if the prospect should be retired from the active set of prospects 68 for a successful campaign outcome or should no longer be considered a possible prospect for the campaign.

1. A system, comprising computer executable instructions for performing the following:
(a). a data store comprising data regarding a plurality of prospects engaged through a sales or fund raising campaign;
(b). a user interacts with the system on a computing device by entering data representing sales or fund raising activities, event information and other campaign related information and receives system data queries and analysis through a graphical user interface;
(c). the system has the capability to perform analytics on the prospects data and display the resulting analytical outcomes which demonstrate the prospects progression within the campaign through a graphical representation of predefined campaign stages indicating stage trend direction with prospect data; and for each stage, system analytics are produced showing the stage's relative health as relating to the entirety of the campaign across various stage and prospect attributes in addition to indicating most valuable actionable items;
(d). the system may perform its operations across a distributed network of computing devices that may be networked by wire or connected wirelessly and independent of the type of computing devices employed throughout the network or on a standalone computing device.

2. The method of claim 1, wherein said methods may take place on a computer, mobile device, tablet, cell phone or other technology capable of running an operating system along with a software application or internet browsing session.

3. The method of claim 1, wherein step (a) input data may be entered into the system h uh physical input, voice input or data import across a network or internet.

4. The method of claim 1, wherein step (c) analysis for the significant phases of a sales campaign or fund raising campaign are implemented through user defined campaign stages which segregate the prospects and their related data to each stage according to their association to each stages data definitions and displays the associated data as pertaining to each stage through numerical embodiments directly associating the data points to a graphical or text embodiment that represents the stage.

5. The method of claim 4, campaign stage interface embodiments may be comprised of a graphic element or text characters, such as a bar, word or other design element, where each stage element is in a linear progression pattern such as horizontally, vertically or circular representing the progression of stages of the campaign from the beginning to the end of the campaign with each stage represented by an individual stage element.

6. The method of claim 4, wherein system users may manage prospects in the system by inputting a prospect at the initial stage in which a prospect is identified as a beginning prospect, As new data is entered and existing data is edited, the system continually evaluates the prospects data against stage data definitions and assigns prospects to an associated stage warranted by their current data.

7. The method of claim 1 wherein the system may demonstrate to the user specific data point conditions by changing interface embodiment colors representing those data points, User defined data parameters set in the system are evaluated by the system against prospect data and then user defined colors are implemented by the system by changing interface embodiment colors to alert the user a change in status of the data has occurred, Prospect volume in a stage may be set to red by the system to indicate the volume is below the user defined parameters for that stage, Likewise the system may change a prospect volume number for a stage from gray, possibly indicating neutral or acceptable levels, to green defining the stage's level has reached exceptional or over performing quantity.

8. The method of claim 1, wherein the system may demonstrate to the user specific data trends by changing interface embodiment colors representing those data trends; user defined data trend parameters set in the system are evaluated in real-time by the system against prospect data and then user defined colors are implemented by the system by changing interface embodiment colors to alert the user a change in status of the data trend has occurred; a stage's graphical element, representing the stage, may be set to red by the system to indicate the stage is trending negatively according to the user defined parameters for that stage; the system may change a stage's graphical element from gray, possibly indicating a neutral or acceptable trend, to green defining the stage's trend has reached exceptional or over performing status.

9. The method of claim 4, wherein the system may present a cumulative effect through the colors implemented across the entire campaign's linear stage interface embodiments and associated data points quickly acclimating the user as to the overall strength of the campaign and directs attention to critical campaign actions by association to the indicated interface embodiments that can best effect the campaign's outcome.

10. The method of claim 4, wherein the system may demonstrate specific data points associated to prospect valuations as relating to campaign outcomes with these valuations being summarized according to their respective campaign stages and demonstrated to the user through an interface embodiment illustrating the total in a location on the screen proximate to it's the respective stage demonstrating the campaigns value proposition as relating to a period of time by associating the campaign stage's prospect value summaries in conjunction with the stage's trend color indicators yielding probability outcomes for a defined period.

11. The method in claim 1, wherein said method may input data by reading data from another data source by connecting to the remote data source either across a wired network or across a wireless network such as the internet and utilizing authorization protocols to login and gain access to the remote systems data.

12. The method in claim 1, wherein said method may import or export data to and from another source across the internet or by using a type of a computer readable storage medium that can be read and written to by the user's device by downloading data from the device running the software application and transporting it to the remote system.

13. The methods in claim 1 and claim 10, wherein said methods may exchange such data by connecting to the remote enterprise application across the internet or wired network and by utilizing a form of authentication extends read write capabilities to the enterprise application and back to the users application.

14. The method in claim 1, wherein said method can generate analytics based upon user interaction with the system and data calculations within the system which derives a calculus which can be applied against a parent data set to enable a predictive analysis model through which the parent set can produce a subset of data for use in the user system that reflects a higher probability of desired outcome for the user to work from.

15. The method in claim 1, wherein said method can model analytics across a data set, that originated in the system at varying times, through a stage based criteria and deliver these analytics as aging by stage allowing the user to better manage prospects by such events or stages verses actual age entered into system.

16. The method in claim 1, wherein said method facilitates a search request to be sent to an external data set for additional data regarding a lead or prospect that can result in the external data set being assembled and return to the application additional prospect data expanding the prospect's demographic data upon which a calculus can be applied resulting in a better dataset for achieving campaign goals.

17. The method in claim 1, wherein said method enables a prospect's objectives to be adjusted through the graphical user interface with the application providing real time quantitative analysis against the entire dataset and displaying the resulting analysis as it affects the campaign while the user moves input controls selecting a prospect target goal in relation to campaign probable outcomes.

18. The method in claim 1, wherein said method enables a user to complete notification tasks through a template library that facilitates rapid completion of notifications by automating field entries based upon notification type and available application data as it relates to the specific notification resulting in a notification completed in the form of an email, word processing document, text message or other electronic communication ready to be sent from the device or archived.

19. The method in claim 1, wherein said method enables the application to maintain data locally on the device on which the application is running, maintain data on a remote system, or maintain data in a hybrid method utilizing both data stored locally and remotely.

20. The method in claim 1, wherein said method enables users to enter subjective evaluations across unrelated system data through interface embodiments using a universal scale facilitating a uniform measurement mechanism for the unrelated data that yields a pulse or feel for the entirety of the data to which it was applied.
